(19) United States
(12) Patent Application Publication
(10) Pub. No.: US 2026/0101208 A1
(43) Pub. Date: Apr. 9, 2026

(54) MEASUREMENT METHOD, METHOD FOR DETERMINING SECONDARY CELL, APPARATUS, DEVICE, AND MEDIUM

(71) Applicant: Beijing Xiaomi Mobile Software Co., Ltd., Beijing (CN)

(72) Inventor: Xuhua TAO, Beijing (CN)

(73) Assignee: Beijing Xiaomi Mobile Software Co., Ltd., Beijing (CN)

(21) Appl. No.: 19/105,216

(22) PCT Filed: Aug. 24, 2022
(86) PCT No.: PCT/CN2022/114572

§ 371 Date: Feb. 20, 2025

(51) Int. Cl. H04W 24/08

(52) U.S. Cl. CPC H04W 24/08

(57) ABSTRACT

A measurement method is performed by a user equipment, and includes: receiving measurement configuration information transmitted by a network device, where the measurement configuration information is to configure N to-be-measured carriers; performing a first measurement on the N to-be-measured carriers when the user equipment is in a non-connected state, to obtain a first measurement result; performing a second measurement on M to-be-measured carriers of the N to-be-measured carriers in response to an access service cell event, to obtain a second measurement result, where M and N are positive integers and M is less than or equal to N; and transmitting the second measurement result to the network device, where the second measurement result is configured to determine a secondary cell in multi-links.

### CROSS REFERENCE TO RELATED APPLICATIONS

This application is a National Phase of International Application No. PCT/CN2022/114572, filed on Aug. 24, 2022, the entire contents of which are incorporated herein by reference in their entireties.

### TECHNICAL FIELD

The present disclosure relates to the field of communication technologies, in particular to a measurement method and apparatus, a method and apparatus for determining a secondary cell, a device, and a readable storage medium.

### BACKGROUND

In the new radio (NR) technology protocol, in order to support the rapid establishment of dual-connectivity (DC) or carrier aggregation (CA) connectivity, an early measurement report (EMR) is introduced, i.e., a user equipment in idle or inactive state can measure and report based on the carrier measurement information configured by a network device. According to the communication protocol requirements, the delay of detecting and measuring a frequency range 2 (FR2) carrier in the FR2 scenario is very long, and considering the carrier number expansion factor, the delay will be further increased.

### SUMMARY

Embodiments of the present disclosure provide a measurement method and apparatus, a method and apparatus for determining a secondary cell, a device, and a readable storage medium.

According to a first aspect of the embodiments of the present disclosure, there is provided a measurement method, performed by a user equipment, and including: receiving measurement configuration information transmitted by a network device, where the measurement configuration information is to configure N to-be-measured carriers; performing a first measurement on the N to-be-measured carriers when the user equipment is in a non-connected state, to obtain a first measurement result; performing a second measurement on M to-be-measured carriers of the N to-be-measured carriers in response to an access service cell event, to obtain a second measurement result, where M and N are positive integers and M is less than or equal to N; and transmitting the second measurement result to the network device, where the second measurement result is configured to determine a secondary cell in multi-links.

In some embodiments, the measurement configuration information is to configure a selection parameter, and the selection parameter includes at least one of: an effective duration threshold, a signal strength threshold, or a priority level.

In some embodiments, the method further includes: selecting, based on the selection parameter and a selection mode corresponding to the selection parameter, the M to-be-measured carriers from the N to-be-measured carriers.

In some embodiments, the effective duration threshold is a first threshold, and the first threshold corresponds to the N to-be-measured carriers.

In some embodiments, the selection mode corresponding to the first threshold includes: in response to a set duration being greater than the first threshold, determining that M is equal to N, and selecting the N to-be-measured carriers, where the set duration is a duration between a first time and a second time, the first time is time when the first measurement is completed, and the second time is time when the access service cell event occurs.

In some embodiments, the effective duration threshold is K second thresholds, each of the K second thresholds corresponds to at least one of the N to-be-measured carriers, K is a positive integer, and K is less than or equal to N.

In some embodiments, the selection mode corresponding to the K second thresholds includes that a second threshold corresponding to a selected to-be-measured carrier is less than a set duration, where the set duration is a duration between a first time and a second time, the first time is time when the first measurement is completed, and the second time is time when the access service cell event occurs.

In some embodiments, the access service cell event is any one of: transmitting a random access request to a service cell, receiving a paging message from the service cell, transmitting a wireless link connection request to the service cell.

In some embodiments, the signal strength threshold is a third threshold, and the third threshold corresponds to the N to-be-measured carriers.

In some embodiments, the selection mode corresponding to the third threshold includes: selecting a to-be-measured carrier, whose signal strength value is greater than the third threshold value, from the first measurement result.

In some embodiments, the signal strength threshold is L fourth thresholds, each of the L fourth thresholds corresponds to at least one of the N to-be-measured carriers, Lis a positive integer, and L is less than or equal to N.

In some embodiments, the selection mode corresponding to the L fourth thresholds includes: selecting a to-be-measured carrier, whose signal strength value is greater than or equal to a fourth threshold corresponding to the to-be-measured carrier, from the first measurement result, or selecting a to-be-measured carrier, whose signal strength value is less than a fourth threshold corresponding to the to-be-measured carrier, from the first measurement result.

In some embodiments, the priority level is a plurality of group priority levels, each of the plurality of group priority levels corresponds to a group, each group includes at least one of the N to-be-measured carriers.

In some embodiments, the selection mode corresponding to the plurality of group priority levels includes that: a selected to-be-measured carrier is a to-be-measured carrier in a set group, where a priority level of the set group is greater than a first set priority level.

In some embodiments, the priority level is a plurality of carrier priority levels, and each of the plurality of carrier priority levels corresponds to a to-be-measured carrier.

In some embodiments, the selection mode corresponding to the plurality of carrier priority levels includes that: a carrier priority level of a selected to-be-measured carrier is greater than a second set priority level.

In some embodiments, the method further includes: transmitting a user equipment capability to the network device, where the user equipment capability is configured to indicate whether the user equipment supports a delay requirement enhancement for the second measurement.

In some embodiments, the second measurement is a measurement for reference signal receiving power based on a layer 1 or a measurement for reference signal receiving power based on a layer 3.

According to a second aspect of the present disclosure, there is provided a method for determining a secondary cell, performed by a network device, and including: transmitting measurement configuration information to a user equipment, where the measurement configuration information is to configure N to-be-measured carriers; receiving a second measurement result transmitted by the user equipment, where the second measurement result is a measurement result obtained by performing a second measurement on M to-be-measured carriers of the N to-be-measured carriers in response to an access service cell event; and determining, based on the second measurement result, a secondary cell in multi-links.

In some embodiments, the measurement configuration information is to configure a selection parameter, and the selection parameter includes at least one of: an effective duration threshold, a signal strength threshold, or a priority level.

In some embodiments, the method further includes: receiving a user equipment capability transmitted by the user equipment, where the user equipment capability is configured to indicate whether the user equipment supports a delay requirement enhancement for the second measurement.

According to a third aspect of the present disclosure, there is provided an electronic device, including a processor and a memory, where the memory is configured to store computer programs; the computer programs, when executed by the processor, cause the processor to perform the method according to the first aspect.

According to a fourth aspect of the present disclosure, there is provided an electronic device, including a processor and a memory, where the memory is configured to store computer programs; the computer programs, when executed by the processor, cause the processor to perform the method according to the second aspect.

According to a fifth aspect of the present disclosure, there is provided a non-transitory computer-readable storage medium, storing instructions thereon, where the instructions, when executed by a computer, cause the computer to perform the method according to the first aspect.

According to an sixth aspect of the present disclosure, there is provided a non-transitory computer-readable storage medium, storing instructions thereon, where the instructions, when executed by a computer, cause the computer to perform the method according to the second aspect.

According to a seventh aspect of the present disclosure, there is provided a communication system including a user device for performing any one of the embodiments and a network device for any one of the embodiments.

### BRIEF DESCRIPTION OF THE DRAWINGS

The drawings described here are used to provide a further understanding of the present specification and constitute a part of the present disclosure. The schematic implementations of the present disclosure and the description thereof are used to explain the present disclosure, and do not constitute an improper limitation on the present disclosure. Among the drawings:

The accompanying drawings, which are incorporated in and constitute a part of this specification, illustrate embodiments consistent with the present disclosure and, together with the description, serve to explain the principles of the disclosure.

FIG. 1 is a schematic diagram illustrating a wireless communication system architecture according to an embodiment of the present disclosure.

FIG. 2 is an interactive schematic diagram illustrating a mode for establishing multi-links according to an embodiment of the present disclosure.

FIG. 3 is an interactive schematic diagram illustrating a mode for establishing multi-links according to another embodiment of the present disclosure.

FIG. 4 is a flowchart illustrating a measurement method according to an embodiment of the present disclosure.

FIG. 5 is a flowchart illustrating a measurement method according to another embodiment of the present disclosure.

FIG. 6 is a flowchart illustrating a method for determining a secondary cell according to an embodiment of the present disclosure.

FIG. 7 is a structural schematic diagram illustrating a measurement apparatus according to an embodiment of the present disclosure.

FIG. 8 is a structural schematic diagram illustrating a measurement device according to another embodiment of the present disclosure.

FIG. 9 is a structural schematic diagram illustrating an apparatus for determining a secondary cell according to an embodiment of the present disclosure.

FIG. 10 is a structural schematic diagram illustrating a device for determining a secondary cell according to another embodiment of the present disclosure.

### DETAILED DESCRIPTION OF THE EMBODIMENTS

The embodiments of the present disclosure will be further described in detail below in conjunction with accompanying drawings and specific examples.

Examples will be described in detail herein, with the illustrations thereof represented in the drawings. Where the following description relates to the drawings, unless otherwise indicated, the same numerals in differ drawings represent the same or similar elements. The embodiments described in the following exemplary embodiments do not represent all embodiments consistent with the present disclosure. Rather, they are merely examples of apparatuses and methods consistent with some aspects of the present disclosure as detailed in the appended claims.

The terms used in the present disclosure are for the purpose of describing a particular example only, and are not intended to limit the present disclosure. The singular forms such as “a,” “said,” and “the” used in the present disclosure and the appended claims are also intended to include multiple, unless the context clearly indicates otherwise. It will also be understood that as used herein, the term “and/or” is and includes any or all combinations of one or more of the associated listed items.

It is to be understood that although different information may be described using the terms such as “first,” “second,” “third,” etc. in the present disclosure, the information should not be limited to these terms. These terms are used only to distinguish the same type of information from each other. For example, the first information may also be referred to as the second information without departing from the scope of the present disclosure, and similarly, the second information may also be referred to as the first information. Depending on the context, as used herein, the wording “if” may be interpreted as “while . . . ” or “when . . . ” or “in response to a determination”.

Hereinafter, the embodiments of the present disclosure will be described in detail, examples of which are illustrated in the accompanying drawings, where the same or similar reference numerals indicate the same or similar elements throughout. The embodiments described below by reference to the accompanying drawings are exemplary and are intended to explain the present disclosure and are not to be construed as limiting the present disclosure.

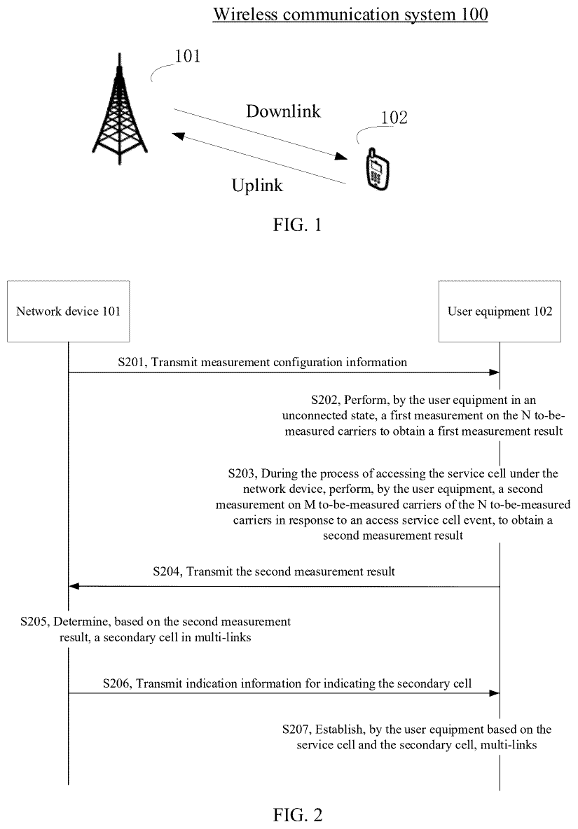

As shown in FIG. 1, an embodiment of the present disclosure provides a method for determining a secondary cell that can be applied to a wireless communication system 100, which may include, but is not limited to, a network device 101 and a user equipment 102. The user equipment 102 is configured to support carrier aggregation, and the user equipment 102 may be connected to a plurality of carrier units of the network device 101, including a primary component carrier unit and one or more secondary component carrier units.

It will be understood that the wireless communication system 100 may be suitable for both low frequency and high frequency scenes. The application scenes of the wireless communication system 100 include, but are not limited to, a long term evolution (LTE) system, an LTE frequency division duplex (FDD) system, an LTE time division duplex (TDD) system, a worldwide interoperability for micro wave access (WiMAX) communication system, a cloud radio access network (CRAN) systems, a future 5th-generation (5G) system, a new radio (NR) communication system, a future evolved public land mobile network (PLMN) system, and other systems.

The user equipment 102 may be a user equipment (UE), a terminal, an access terminal, a terminal unit, a terminal station, a mobile station (MS), a remote station, a remote terminal, a mobile terminal, a wireless communication device, a terminal agent, etc. The user equipment 102 may have a wireless receiving and transmitting function, which is capable of communicating (e.g., wireless communication) with one or more network devices 101 of one or more communication systems and accepting network services provided by the network devices 101, which herein include, but are not limited to, a base station illustrated.

The user equipment 102 may be a cellular telephone, a cordless telephone, a session initiation protocol (SIP) telephone, a wireless local loop (WLL) station, a personal digital assistant (PDA) device, a handheld device with wireless communication capabilities, a computing device, other processing devices connected to wireless modems, an on-board device, a wearable device, a user equipment in a future 5G network or in a future evolved PLMN network, and so on.

The network device 101 may be an access network device (or access network station). The access network device is a device that has the function of providing network access, such as a radio access network (RAN) base station and the like. The network device may include a base station (BS) device, or include a BS device and a wireless resource management device for controlling the BS device, and the like. The network device may also include relay stations (relay devices), access points, and base stations in the future 5G network, and base stations or NR base stations in the future evolved PLMN network, and the like. The network device may be a wearable device or an on-board device. The network device can also be a communication chip with a communication module.

For example, the network device 101 includes, but is not limited to, a next-generation base station (gnodeB, gNB) in 5G, an evolved node B (eNB) in an LTE system, a radio network controller (RNC), a node B (NB) in a wideband code division multiple access (WCDMA) system, a wireless controller in a centralized radio access network (CRAN) system, a base station controllers (BSC), a base transceiver station (BTS) in a global system for mobile communication (GSM) or code division multiple access (CDMA) system, and a home base stations (e.g., home evolved node B, or home node B (HNB)), a baseband unit (BBU), a transmitting and receiving point (TRP), a transmitting point (TP), or a mobile switching center.

An early measurement report (EMR) is introduced, i.e., a user equipment in idle or inactive state can measure and report based on the carrier measurement information configured by a network device. According to the communication protocol requirements, the delay of detecting and measuring a frequency range 2 (FR2) carrier in the FR2 scenario is very long, and considering the carrier number expansion factor, the delay will be further increased. The inventor found in their research that such a long delay requirement may lead to an unreliable measurement result of the EMR reported by the user equipment.

Further, the inventor found in their research that after the user equipment completes EMR in the idle state or in the inactive state, the duration for initiating a radio resource control (RRC) establishment request in the process of accessing the service cell is uncertain, and, the duration for completing the establishment of the RRC connection also causes the measurement of the EMR reported by the user equipment to expire and become untrustworthy. Based on the measurement report of EMR, determining the secondary cell in multi-links may result in poor signal quality of the identified secondary cells, leading to poor link performance of the link between the user equipment and the secondary cell in the multi-links and affecting the link quality of the multi-links.

In the present disclosure, the user equipment in an idle state or an inactive state accesses a service cell after completing an early measurement report (EMR), and in the process of accessing the service cell, some or all of the carriers that have been measured in the EMR are measured again in order to prevent the measurement results of the EMR from having expired, and this measurement that is performed again can be considered as an enhanced measurement of the EMR, and the measurement result of this enhanced measurement is more accurate than the measurement result of the EMR, so that the secondary cell in the multi-links can be determined based on the measurement result of the enhanced measurement, and the secondary cell with better signal quality can be determined, so as to ensure the link performance of the link between the user equipment and the secondary cell in the multi-links, and to improve the overall link quality of the multi-links.

An embodiment of the present disclosure provides a method for determining a secondary cell. FIG. 2 is a flowchart illustrating a method for determining a secondary cell according to the embodiment of the present disclosure. As shown in FIG. 2, the method includes the following steps S201 to S207.

At step S201, the network device transmits measurement configuration information to the user equipment, where the measurement configuration information is to configure N to-be-measured carriers.

In some embodiments, the N to-be-measured carriers include N new radio (NR) carriers, or N long term evolution (LTE) carriers, or a plurality of NR carriers and a plurality of LTE carriers, and the sum of the number of the plurality of NR carriers and the number of the plurality of LTE carriers is N.

At step S202, the user equipment in a non-connected state (an idle/inactive state) performs a first measurement on the N to-be-measured carriers to obtain a first measurement result.

In some embodiments, the non-connected state is an idle state or an inactive state.

At step S203, during the process of accessing the service cell under the network device, the user equipment performs a second measurement on M to-be-measured carriers of the N to-be-measured carriers in response to an access service cell event, to obtain a second measurement result.

M and N are positive integers and M is less than or equal to N.

In some embodiments, the access service cell event is one of: transmitting a random access request to a service cell, receiving a paging message from the service cell, and transmitting a wireless link connection request to the service cell.

In some embodiments, during the process of accessing the service cell under the network device, the user equipment performs a second measurement on the N to-be-measured carriers in response to an access service cell event, to obtain a second measurement result.

In some embodiments, the second measurement is a measurement for reference signal receiving power based on a layer 1 (L1_RSRP) or a measurement for reference signal receiving power based on a layer 3 (L3_RSRP).

At step S204, the user equipment transmits the second measurement result to the network device.

At step S205, the network device determines, based on the second measurement result, a secondary cell in multi-links.

At step S206, the network device transmits indication information to the user equipment to indicate the secondary cell.

At step S207, the user equipment establishes multi-links based on the service cell and the secondary cell.

In the present disclosure, the user equipment in an idle state or an inactive state accesses a service cell after completing an early measurement report (EMR), and in the process of accessing the service cell, some or all of the carriers that have been measured in the EMR are measured again in order to prevent the measurement results of the EMR from having expired, and this measurement that is performed again can be considered as an enhanced measurement of the EMR, and the measurement result of this enhanced measurement is more accurate than the measurement result of the EMR, so that the secondary cell in the multi-links can be determined based on the measurement result of the enhanced measurement, and the secondary cell with better signal quality can be determined, so as to ensure the link performance of the link between the user equipment and the secondary cell in the multi-links, and to improve the overall link quality of the multi-links.

In some embodiments, in step S203, during the process of accessing the service cell under the network device, the user equipment performs a second measurement on set M to-be-measured carriers of the N to-be-measured carriers in response to an access service cell event, to obtain a second measurement result. For example, if M is less than N, the set M to-be-measured carriers are known by the user equipment according to the agreement, or from the indication information transmitted by the network equipment, or are default.

In some embodiments, before step S202, the user equipment transmits a user equipment capability to the network device, where the user equipment capability is configured to indicate whether the user equipment supports a delay requirement enhancement for the second measurement.

The delay requirement enhancement for the second measurement includes the delay requirement enhancement for the layer 1 measurement and/or the delay requirement enhancement for the layer 3 measurement.

In some embodiments, supporting the delay requirement enhancement for the layer 1 measurement refers to supporting delay reduction for the layer 1 measurement. In some embodiments, supporting the delay requirement enhancement for the layer 1 measurement refers to supporting the delay for the Layer 1 measurement that is less than the agreed duration, which is less than the delay for the Layer 1 measurement defined in an existing protocol. The existing protocol may be a R16 or R17 protocol.

Supporting the delay requirement enhancement for the layer 3 measurement refers to supporting delay reduction for the layer 3 measurement. In some embodiments, supporting the delay requirement enhancement for the layer 3 measurement refers to supporting the delay for the Layer 3 measurement that is less than the agreed duration, which is less than the delay for the Layer 3 measurement defined in existing protocols.

In an example, the user equipment (UE) in the idle state or in the inactive state performs the EMR measurement on N to-be-measured carriers and obtains a first measurement result. After the UE initiates a radio resource control (RRC) connection establishment request to the network, it is required to perform L1_RSRP measurement on M to-be-measured carriers of the N to-be-measured carriers. If the UE has already performed the confirmation process for receiving beams during the previous L1_RSRP measurement, the UE, when performing this L1_RSRP measurement, does not need to perform the receiving beam sweeping (Rxbeamsweeping), or needs to perform the receiving beam sweeping but the number of sweeping can be reduced, e.g., instead of sweeping eight times, only sweeping four or two times are needed to determine the optimal receiving beam, and thus the delay for the UE to perform the L1_RSRP measurement can be reduced. In this case, when the UE has already performed the confirmation process for receiving beams during the previous L1_RSRP measurement, the UE transmits the user equipment capability to the network device, which is used to indicate that the UE supports the delay requirement enhancement for the L1 RSRP measurement.

In an example, the UE in the idle state or in the inactive state performs the EMR measurement on N to-be-measured carriers and obtains a first measurement result. After the UE initiates the RRC connection establishment request to the network, it is required to perform L3 RSRP measurement on M to-be-measured carriers of the N to-be-measured carriers. If the UE has the capability to receive downlink signals by using multiple receiving beams at the same time (e.g., the capability to receive downlink signals by using two receiving beams at the same time), the UE, when performing this L3_RSRP measurement, needs to perform the receiving beam sweeping but the number of sweeping can be reduced, e.g., instead of sweeping eight times, only sweeping four or two times are needed to determine the optimal receiving beam, and thus the delay for the UE to perform the L1_RSRP measurement can be reduced. In this case, when the UE has the capability to receive downlink signals by using multiple receiving beams at the same time, the UE transmits the user equipment capability to the network device, which is used to indicate that the UE supports the delay requirement enhancement for the L3_RSRP measurement.

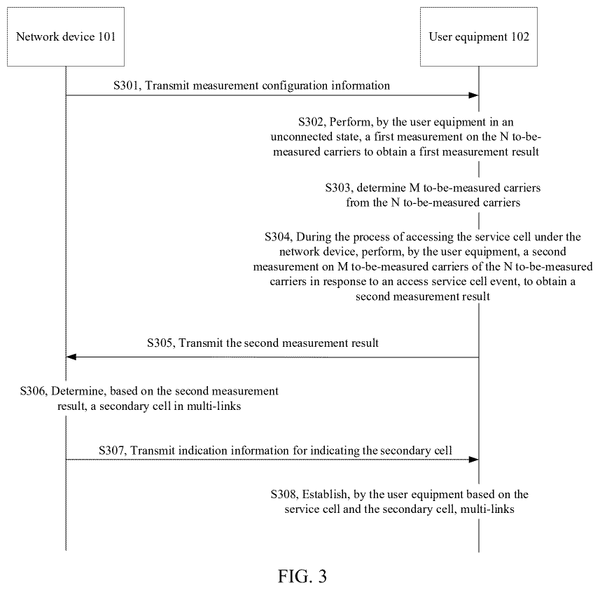

An embodiment of the present disclosure provides a method for establishing multi-links. FIG. 3 is a flowchart illustrating a method for establishing multi-links according to another embodiment of the present disclosure. As shown in FIG. 3, the method includes the following steps S301 to S308.

At step S301, the network device transmits measurement configuration information to the user equipment, where the measurement configuration information is to configure N to-be-measured carriers.

In some embodiments, the N to-be-measured carriers include N new radio (NR) carriers, or N long term evolution (LTE) carriers, or a plurality of NR carriers and a plurality of LTE carriers, and the sum of the number of the plurality of NR carriers and the number of the plurality of LTE carriers is N.

At step S302, the user equipment in a non-connected (an idle/inactive state) state performs a first measurement on the N to-be-measured carriers to obtain a first measurement result.

In some embodiments, the non-connected state is an idle state or an inactive state.

At step S303, the user equipment determines M to-be-measured carriers from the N to-be-measured carriers. M and N are positive integers and M is less than or equal to N.

At step S304, during the process of accessing the service cell under the network device, the user equipment performs a second measurement on the M to-be-measured carriers of the N to-be-measured carriers in response to an access service cell event, to obtain a second measurement result.

In some embodiments, the second measurement is a measurement for reference signal receiving power based on a layer 1 (L1_RSRP) or a measurement for reference signal receiving power based on a layer 3 (L3_RSRP).

In some embodiments, the access service cell event is one of: transmitting a random access request to a service cell, receiving a paging message from the service cell, and transmitting a wireless link connection request to the service cell.

At step S305, the user equipment transmits the second measurement result to the network device.

At step S306, the network device determines, based on the second measurement result, a secondary cell in multi-links.

At step S307, the network device transmits indication information to the user equipment to indicate the secondary cell.

At step S308, the user equipment establishes multi-links based on the service cell and the secondary cell.

In the present disclosure, the user equipment in an idle state or an inactive state accesses a service cell after completing an early measurement report (EMR), and in the process of accessing the service cell, a part of the carriers that have been measured in the EMR are measured again in order to prevent the measurement results of the EMR from having expired, and this measurement that is performed again can be considered as an enhanced measurement of the EMR, and the measurement result of this enhanced measurement is more accurate than the measurement result of the EMR, so that the secondary cell in the multi-links can be determined based on the measurement result of the enhanced measurement, and the secondary cell with better signal quality can be determined, so as to ensure the link performance of the link between the user equipment and the secondary cell in the multi-links, and to improve the overall link quality of the multi-links. In addition, compared to measuring all of the carriers measured in the EMR, a part of the carriers that have been measured in the EMR are measured again, such that the measurement capacity of the user equipment can be saved and the duration of the establishment of the multi-links can be further shortened.

The mode in which the user equipment in step S303 determines M to-be-measured carriers from the N to-be-measured carriers is described in detail below. This can be achieved in three modes.

### Mode I

In step S301, the measurement configuration information is further to configure a selection parameter, and the selection parameter is an effective duration threshold.

In step S303, the user equipment selects, based on the effective duration threshold and a selection mode corresponding to the effective duration threshold, the M to-be-measured carriers from the N to-be-measured carriers.

There can be two cases regarding the effective duration threshold, in the first case the effective duration threshold is a first threshold used for all of the N to-be-measured carriers, and in the second case the effective duration threshold is a plurality of second thresholds, each second threshold is used for different one or more to-be-measured carriers.

The two cases will be explained in detail below.
First case:

The effective duration threshold is a first threshold, and the first threshold corresponds to the N to-be-measured carriers.

The selection mode corresponding to the first threshold includes: in response to a set duration being greater than the first threshold, determining that M is equal to N, and selecting the N to-be-measured carriers, where the set duration is a duration between a first time and a second time (a duration from a first time to a second time), the first time T1 is time when the first measurement is completed, and the second time T2 is time when the access service cell event occurs.

In an example, the time when the user equipment in the idle state or the inactive state completes the EMR measurement is T1, and the time when the user equipment transmits the RRC connection request to the network device is T2. If the duration between T2 and T1 (i.e., the duration from T1 to T2) is greater than or equal to a first threshold (e.g., the first threshold is 5 milliseconds), the N to-be-measured carriers are selected. If the duration between T2 and T1 (i.e., the duration from T1 to T2) is less than the first threshold, there is no need to select any one of the N to-be-measured carriers.

That is, if the duration between T2 and T1 (i.e., the duration from T1 to T2) is greater than or equal to a first threshold (e.g., the first threshold is 5 milliseconds), the enhanced measurement needs to be performed on all of the N to-be-measured carriers, and if the duration between T2 and T1 (i.e., the duration from T1 to T2) is less than the first threshold, there is no need to perform the enhanced measurement on any one of the N to-be-measured carriers.

In another example, after the user equipment in the idle state or in the inactive state completes the EMR measurement, the user equipment starts a timer with a timing duration of a first threshold (e.g., the first threshold of 5 milliseconds), and when the user equipment transmits an RRC connection request to the network device, the N to-be-measured carriers are selected if the timer has timed out, and there is no need to select any one of the N to-be-measured carriers if the timer has not timed out.

Accordingly, when the user equipment transmits an RRC connection request to the network device, if the timer has timed out, it is necessary to perform the enhanced measurement on all of the N to-be-measured carriers, and if the timer has not timed out, there is no need to select any one of the N to-be-measured carriers.
Second case:

The effective duration threshold is K second thresholds, each of the K second thresholds corresponds to at least one of the N to-be-measured carriers, K is a positive integer, and K is less than or equal to N.

The selection mode corresponding to the K second thresholds includes that a second threshold corresponding to a selected to-be-measured carrier is less than a set duration, where the set duration is a duration between a first time and a second time (a duration from a first time to a second time), the first time T1 is time when the first measurement is completed, and the second time T2 is time when the access service cell event occurs.

It is to be noted that the measurement configuration information transmitted by the network device indicates, in addition to the K second thresholds, a correspondence of each second threshold with at least one to-be-measured carrier. For example, the measurement configuration information for indication may be in the form of information pairs, each of the information pairs includes a first information and a second information. The first information is configured to indicate a second threshold, and the second information is configured to indicate one or more to-be-measured carriers corresponding to the second threshold.

In an example,

the value of N is 10, and the value of K is 10. The user equipment measures ten to-be-measured carriers in the EMR measurement and obtains ten second thresholds from the network device. The 1st second threshold (Thre_1) corresponds to the first to-be-measured carrier, the 2nd second threshold (Thre_2) corresponds to the to-be-measured carrier, and so on. The 10th second threshold (Thre_10) corresponds to the 10th to-be-measured carrier.

The time when the user equipment in idle or inactive state completes the EMR measurement is T1, and the time when the user equipment transmits a RRC connection request to the network equipment is T2. If the duration between T2 and T1 (i.e., the duration from T1 to T2) is greater than or equal to some of the ten second thresholds, the to-be-measured carriers respectively corresponding to these second thresholds are selected.

If the duration between T2 and T1 (i.e., the duration from T1 to T2) is greater than the 1st second threshold (Thre_1) and the 2nd second threshold (Thre_2), and the duration between T2 and T1 (i.e., the duration from T1 to T2) is less than any one of the other 8 second thresholds. The 1st to-be-measured carrier corresponding to the 1st second threshold (Thre_1) and the 2nd to-be-measured carrier corresponding to the 2nd second threshold (Thre_2) are selected, without selecting the other 8 to-be-measured carriers. That is, the enhanced measurement needs to be performed on the 1st to-be-measured carrier and the 2nd to-be-measured carrier, while the enhanced measurement needs not be performed on the other 8 to-be-measured carriers.

### Mode II

In step S301, the measurement configuration information is further to configure a selection parameter, and the selection parameter includes a signal strength threshold.

In step S303, the user equipment selects, based on the signal strength threshold and a selection mode corresponding to the signal strength threshold, the M to-be-measured carriers from the N to-be-measured carriers.

There can be two cases regarding the signal strength threshold, in the first case the signal strength threshold is a third threshold used for all of the N to-be-measured carriers, and in the second case the signal strength threshold is a plurality of fourth thresholds, each fourth threshold is used for different one or more to-be-measured carriers.

The two cases will be explained in detail below.
First case:

The signal strength threshold is a third threshold, and the third threshold corresponds to the N to-be-measured carriers.
where the selection mode corresponding to the third threshold includes: selecting a to-be-measured carrier, whose signal strength value is greater than the third threshold value, from the first measurement result.

Specifically, the user equipment in the idle state or in the inactive state obtains a first measurement result after completing the EMR measurement, the first measurement result includes signal strength values obtained from the measurement of each of the N to-be-measured carriers, and a to-be-measured carrier whose signal strength value is greater than the third threshold value is selected from the first measurement result.

In this first case, the to-be-measured carrier with a larger signal strength value is selected for the enhanced measurement, and secondary cell with better signal quality can be accurately selected when the expired duration of the EMR measurement result is shorter, i.e., more credible.

In an example,
the value of N is 10, and the user equipment in the idle state or the inactive state is required to measure ten to-be-measured carriers when performing the EMR measurement to obtain a first measurement result. The first measurement result includes signal strength values obtained by measuring each of the ten to-be-measured carriers. If the signal strength value obtained by measuring the first to-be-measured carrier, the signal strength value obtained by measuring the second to-be-measured carrier and the signal strength value obtained by measuring the third to-be-measured carrier are all greater than the third threshold, and the signal strength values obtained by measuring the other seven to-be-measured carriers are all less than the third threshold, the first to-be-measured carrier, the second to-be-measured carrier and the third to-be-measured carrier are selected, and the other seven to-be-measured carriers are not selected.

That is, the enhanced measurement needs to be performed on the first to-be-measured carrier, the second to-be-measured carrier and the third to-be-measured carrier, while the enhanced measurement needs not be performed on the other seven to-be-measured carriers.
Second case:

The signal strength threshold is L fourth thresholds, each of the L fourth thresholds corresponds to at least one of the N to-be-measured carriers, L is a positive integer, and L is less than or equal to N.

The selection mode corresponds to the L fourth thresholds includes: selecting a to-be-measured carrier, whose signal strength value is greater than or equal to a fourth threshold corresponding to the to-be-measured carrier, from the first measurement result, or selecting a to-be-measured carrier, whose signal strength value is less than a fourth threshold corresponding to the to-be-measured carrier, from the first measurement result.

It is to be noted that the measurement configuration information transmitted by the network device indicates, in addition to the L fourth thresholds, a correspondence of each fourth threshold with at least one to-be-measured carrier. For example, the measurement configuration information for indication may be in the form of information pairs, each of the information pairs includes a first information and a second information. The first information is configured to indicate a fourth threshold, and the second information is configured to indicate one or more to-be-measured carriers corresponding to the fourth threshold.

In this second case, the to-be-measured carrier with a larger signal strength value is selected for the enhanced measurement, and secondary cell with better signal quality can be accurately selected when the expired duration of the EMR measurement result is shorter, i.e., more credible. In this first case, the to-be-measured carrier with a smaller signal strength value is selected for the enhanced measurement, and the measurement capacity of the user equipment is saved when the expired duration of the EMR measurement result is longer, i.e., less reliable.

In an example,
the value of N is 10, and the value of L is 10. The user equipment in the idle state or the inactive state measures ten to-be-measured carriers in the EMR measurement and obtains ten fourth thresholds from the network device. Each to-be-measured carrier corresponds to a fourth threshold.

The user equipment in the idle state or the inactive state is required to measure ten to-be-measured carriers after performing the EMR measurement to obtain a first measurement result. The first measurement result includes signal strength values obtained by measuring each of the ten to-be-measured carriers. If the signal strength value obtained by measuring the first to-be-measured carrier is greater than a fourth threshold corresponding to the first to-be-measured carrier, the signal strength value obtained by measuring the second to-be-measured carrier is greater than a fourth threshold corresponding to the second to-be-measured carrier, and each of the signal strength values obtained by measuring the other to-be-measured carriers is less than a corresponding fourth threshold, the first to-be-measured carrier, and the second to-be-measured carrier are selected, and the other eight to-be-measured carriers are not selected.

In another example, the value of N is 10, and the value of L is 3. The user equipment in the idle state or the inactive state measures ten to-be-measured carriers in the EMR measurement and obtains three fourth thresholds from the network device. The 1st to 4th to-be-measured carriers correspond to the 1st fourth threshold, the 5th to 8th to-be-measured carriers correspond to the 2nd fourth threshold, and the 9th to 10th to-be-measured carriers correspond to the 3rd fourth threshold.

The user equipment in the idle state or the inactive state is required to measure ten to-be-measured carriers after performing the EMR measurement to obtain a first measurement result. The first measurement result includes signal strength values obtained by measuring each of the ten to-be-measured carriers. If the signal strength value obtained by measuring the first to-be-measured carrier is greater than a fourth threshold corresponding to the first to-be-measured carrier, and each of the signal strength values obtained by measuring the other to-be-measured carriers is less than a corresponding fourth threshold, the first to-be-measured carrier is selected, and the other nine to-be-measured carriers are not selected.

### Mode III

In step S301, the measurement configuration information is further to configure a selection parameter, and the selection parameter includes a priority level.

In step S303, based on the priority level and a selection mode corresponding to the priority level, the M to-be-measured carriers from the N to-be-measured carriers are selected.

There can be two cases regarding the priority level. In the first case, the priority level is a plurality of group priority levels, each group includes at least one of the N to-be-measured carriers, and each group corresponds to a group priority level. In the second case, the priority level is a plurality of carrier priority levels, and each of the plurality of carrier priority levels corresponds to a to-be-measured carrier.

The two cases will be explained in detail below.
First case:

The priority level is a plurality of group priority levels, each of the plurality of group priority levels corresponds to a group, each group includes at least one of the N to-be-measured carriers.

The selection mode corresponds to the plurality of group priority levels includes that: a selected to-be-measured carrier is a to-be-measured carrier in a set group, where a priority level of the set group is greater than a first set priority level.

It is to be noted that the measurement configuration information transmitted by the network device indicates, in addition to the plurality of group priority levels, the correspondence between each of the plurality of group priority levels and a group, and the correspondence between a group and a to-be-measured carrier (i.e., which to-be-measured carriers are included in a group). For example, the measurement configuration information for indication may be in the form of information groups, each of the information groups includes a first information, a second information and a third information. The first information is configured to indicate a group priority level, the second information is configured to indicate a group corresponding to the group priority level, and the third information is configured to indicate one or more to-be-measured carriers included in the group.

The user equipment is informed of a first set priority level based on a covenant agreement, or is informed of the first set priority level from an indication information transmitted by the network device, or the first set priority level is default.

In an example, the value of N is 10, and there are three priority levels, corresponding to three groups.

The user equipment in the idle state or the inactive state measures ten to-be-measured carriers in the EMR measurement and obtains three group priority levels from the network device.

A group priority level of a first group is H. The first group includes a first to third to-be-measured carriers. A group priority level of a second group is M. The second group includes a fourth to eighth to-be-measured carriers. A group priority level of a third group is L. The third group includes a ninth to tenth to-be-measured carriers. The group priority levels are, in descending order, H, M, L.

After the user equipment completes the EMR measurement in the idle state or the inactive state, when the first set priority level is M, it selects a group with a group priority level greater than M as a first group based on the three priority levels, selects all of the to-be-measured carriers in the first group, and finally selects the to-be-measured carriers to be the first to third to-be-measured carriers.
Second case:

The priority level is a plurality of carrier priority levels, and each of the plurality of carrier priority levels corresponds to a to-be-measured carrier.

where the selection mode corresponding to the plurality of carrier priority levels includes that: a carrier priority level of a selected to-be-measured carrier is greater than a second set priority level.

The user equipment is informed of the second set priority level based on a covenant agreement, or is informed of the second set priority level from an indication information transmitted by the network device, or the second set priority level is default.

It is to be noted that the measurement configuration information transmitted by the network device indicates, in addition to carrier priority levels, the correspondence between each carrier priority level and a to-be-measured carrier. For example, the measurement configuration information for indication may be in the form of information pairs, each of the information pairs includes a first information and a second information. The first information is configured to indicate a to-be-measured carrier, and the second information is configured to indicate a carrier priority level of the to-be-measured carrier.

In an example, a value of N is 10, there are four carrier priority levels, the carrier priority levels are, in descending order, A1, A2, A3 and A4.

The user equipment in the idle state or the inactive state measures ten to-be-measured carriers in the EMR measurement and obtains a carrier priority level of each to-be-measured carrier from the network device.

After the user equipment completes the EMR measurement in the idle state or the inactive state, when the first set priority level is A3, a to-be-measured carrier with a carrier priority level A1 or A2 is selected.

### Mode IV

In step S301, the measurement configuration information is further to configure a selection parameter, and the selection parameter includes two of an effective duration threshold, a signal strength threshold, and a priority level.

In step S303, based on the selection parameter and a selection mode corresponding to the selection parameter, the M to-be-measured carriers from the N to-be-measured carriers are selected.

In the mode IV, two selection parameters are used to select a to-be-measured carrier that satisfies both selection modes, which further saves the measurement capability of the user equipment relative to using one selection parameter.

In an example:

In step S301, the measurement configuration information is further to configure a selection parameter, and the selection parameter includes an effective duration threshold, and a signal strength threshold.

In step S303, based on the effective duration threshold, the signal strength threshold, a selection mode corresponding to the effective duration threshold, and a selection mode corresponding to the signal strength threshold, the M to-be-measured carriers from the N to-be-measured carriers are selected. Alternatively, it will be understood as selecting, based on the effective duration threshold and the signal strength threshold, the M to-be-measured carriers from the N to-be-measured carriers, that meet the selection mode corresponding to the effective duration threshold and the selection mode corresponding to the signal strength threshold.

### Mode V

In step S301, the measurement configuration information is further to configure a selection parameter, and the selection parameter includes an effective duration threshold, a signal strength threshold, and a priority level.

In step S303, based on the selection parameter and a selection mode corresponding to the selection parameter, the M to-be-measured carriers from the N to-be-measured carriers are selected.

In the mode V, three selection parameters are used to select a to-be-measured carrier that satisfies three selection modes, which further saves the measurement capability of the user equipment relative to using one or two selection parameters.

In some embodiments, before step S202, the user equipment transmits a user equipment capability to the network device, where the user equipment capability is configured to indicate whether the user equipment supports a delay requirement enhancement for the second measurement.

The delay requirement enhancement for the second measurement includes the delay requirement enhancement for the layer 1 measurement and/or the delay requirement enhancement for the layer 1 measurement.

In some embodiments, supporting the delay requirement enhancement for the layer 1 measurement refers to supporting delay reduction for the layer 1 measurement. In some embodiments, supporting the delay requirement enhancement for the layer 1 measurement refers to supporting the delay for the Layer 1 measurement that is less than the agreed duration, which is less than the delay for the Layer 1 measurement defined in existing protocols. The existing protocol may be a R16 or R17 protocol.

Supporting the delay requirement enhancement for the layer 3 measurement refers to supporting delay reduction for the layer 3 measurement. In some embodiments, supporting the delay requirement enhancement for the layer 3 measurement refers to supporting the delay for the Layer 3 measurement that is less than the agreed duration, which is less than the delay for the Layer 3 measurement defined in existing protocols. The existing protocol may be a R16 or R17 protocol.

In an example, the user equipment (UE) in the idle state or in the inactive state performs the EMR measurement on N to-be-measured carriers and obtains a first measurement result. After the UE initiates a radio resource control (RRC) connection establishment request to the network, it is required to perform L1_RSRP measurement on M to-be-measured carriers of the N to-be-measured carriers, and if the UE has already performed the receiving beam confirmation process during the previous L1_RSRP measurement, the UE does not need to perform the receiving beam sweeping (Rxbeamsweeping) when performing this L1_RSRP measurement, or it needs to perform the receiving beam sweeping but the number of sweeping can be reduced, e.g., instead of sweeping eight times, only sweeping four or two times are needed to determine the optimal receiving beams, and thus the delay for the UE to perform the L1_RSRP measurement can be reduced. In this case, when the UE has already performed the confirmation process for receiving beams during the previous L1_RSRP measurement, the UE transmits the user equipment capability to the network device, which is used to indicate that the UE supports the delay requirement enhancement for the L1 RSRP measurement.

In an example, the UE in the idle state or in the inactive state performs the EMR measurement on N to-be-measured carriers and obtains a first measurement result. After the UE initiates the RRC connection establishment request to the network, it is required to perform L3 RSRP measurement on M to-be-measured carriers of the N to-be-measured carriers. If the UE has the capability to receive downlink signals by using multiple receiving beams at the same time (e.g., the capability to receive downlink signals by using two receiving beams at the same time), the UE, when performing this L1_RSRP measurement, needs to perform the receiving beam sweeping but the number of sweeping can be reduced, e.g., instead of sweeping eight times, only sweeping four or two times are needed to determine the optimal receiving beam, and thus the delay for the UE to perform the L1_RSRP measurement can be reduced. In this case, when the UE has the capability to receive downlink signals by using multiple receiving beams at the same time, the UE transmits the user equipment capability to the network device, which is used to indicate that the UE supports the delay requirement enhancement for the L3_RSRP measurement.

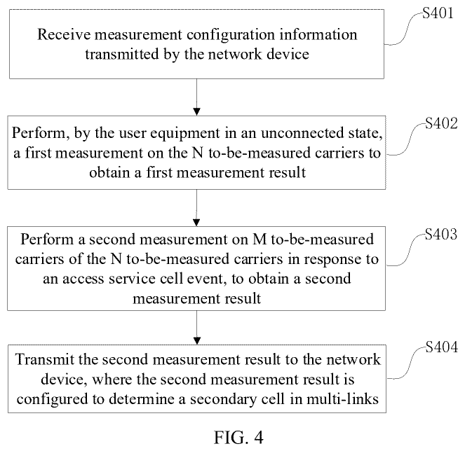

An embodiment of the present disclosure provides a measurement method which is performed by a user equipment. FIG. 4 is a flowchart illustrating a measurement method according to the embodiment of the present disclosure. As shown in FIG. 4, the method includes the following steps S401 to S404.

At step S401, measurement configuration information transmitted by the network device is received.

The measurement configuration information is to configure N to-be-measured carriers.

At step S402, the user equipment in a non-connected (an idle/inactive state) state performs a first measurement on the N to-be-measured carriers to obtain a first measurement result.

At step S403, the user equipment performs a second measurement on M to-be-measured carriers of the N to-be-measured carriers in response to an access service cell event, to obtain a second measurement result.

M and N are positive integers and M is less than or equal to N.

At step S404, the second measurement result is transmitted to the network device, where the second measurement result is configured to determine a secondary cell in multi-links.

The measurement method in embodiments of the present disclosure may be applied in the process of establishing multi-links by a user equipment, and by means of this measurement method, the link quality of a link between the user equipment and the secondary cell in the establishment of the multi-links may be improved, thereby the overall link quality of the multi-links is improved.

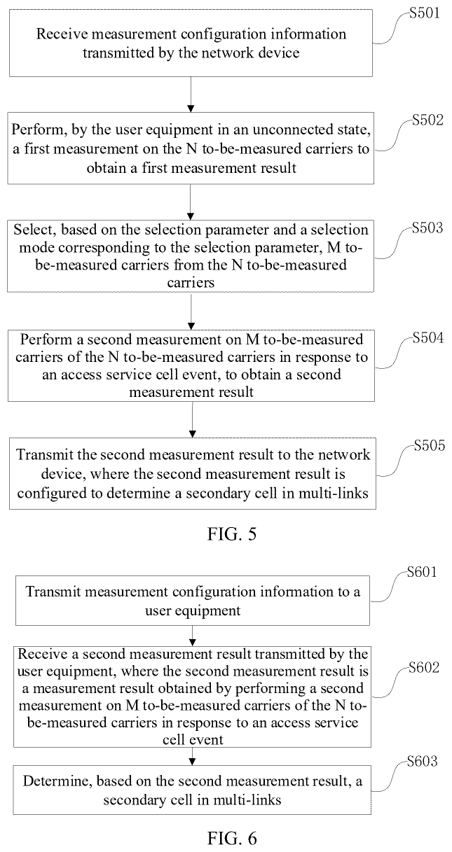

An embodiment of the present disclosure provides a measurement method which is performed by a user equipment. FIG. 5 is a flowchart illustrating a measurement method according to the embodiment of the present disclosure. As shown in FIG. 5, the method includes the following steps S501 to S505.

At step S501, measurement configuration information transmitted by the network device is received.

The measurement configuration information is to configure N to-be-measured carriers. The measurement configuration information is to configure a selection parameter, and the selection parameter includes at least one of: an effective duration threshold, a signal strength threshold, or a priority level.

At step S502, the user equipment in a non-connected state (an idle/inactive state) performs a first measurement on the N to-be-measured carriers to obtain a first measurement result.

At step S503, M to-be-measured carriers from the N to-be-measured carriers are selected based on the selection parameter and a selection mode corresponding to the selection parameter.

At step S504, the user equipment performs a second measurement on M to-be-measured carriers of the N to-be-measured carriers in response to an access service cell event, to obtain a second measurement result.

M and N are positive integers and M is less than or equal to N.

At step S505, the second measurement result is transmitted to the network device, where the second measurement result is configured to determine a secondary cell in multi-links.

The measurement method in embodiments of the present disclosure may be applied in the process of establishing multi-links by a user equipment, and by means of this measurement method, the measurement capability of the user equipment can be saved, and the link quality of a link between the user equipment and the secondary cell in the establishment of the multi-links may be improved, thereby the overall link quality of the multi-links is improved.

In step S501, when the selection parameter configured by the measurement configuration information includes an effective duration threshold, there can be two cases regarding the effective duration threshold, in the first case the effective duration threshold is a first threshold used for all of the N to-be-measured carriers, and in the second case the effective duration threshold is a plurality of second thresholds, each second threshold is used for different one or more to-be-measured carriers.

In the first case, the effective duration threshold is a first threshold, and the first threshold corresponds to the N to-be-measured carriers.

The selection mode corresponding to the first threshold includes: in response to a set duration being greater than the first threshold, determining that M is equal to N, and selecting the N to-be-measured carriers, where the set duration is a duration between a first time and a second time (a duration from a first time to a second time), the first time is time when the first measurement is completed, and the second time is time when the access service cell event occurs.

In the second case, the effective duration threshold is K second thresholds, each of the K second thresholds corresponds to at least one of the N to-be-measured carriers, K is a positive integer, and K is less than or equal to N.

The selection mode corresponding to the K second thresholds includes that a second threshold corresponding to a selected to-be-measured carrier is less than a set duration, where the set duration is a duration between a first time and a second time (a duration from a first time to a second time), the first time is time when the first measurement is completed, and the second time is time when the access service cell event occurs.

In some embodiments, the access service cell event is one of: transmitting a random access request to a service cell, receiving a paging message from the service cell, and transmitting a wireless link connection request to the service cell.

In step S501, when the selection parameter configured by the measurement configuration information includes a signal strength threshold, there can be two cases regarding the signal strength threshold.

In the first case, the signal strength threshold is a third threshold, and the third threshold corresponds the N to-be-measured carriers. the selection mode corresponding to the third threshold includes: selecting a to-be-measured carrier, whose signal strength value is greater than the third threshold, from the first measurement result.

In the second case, the signal strength threshold is L fourth thresholds, each of the L fourth thresholds corresponds to at least one of the N to-be-measured carriers, L is a positive integer, and L is less than or equal to N. The selection mode corresponding to the L fourth thresholds includes: selecting a to-be-measured carrier, whose signal strength value is greater than or equal to a fourth threshold corresponding to the to-be-measured carrier, from the first measurement result, or selecting a to-be-measured carrier, whose signal strength value is less than a fourth threshold corresponding to the to-be-measured carrier, from the first measurement result.

In step S501, when the selection parameter configured by the measurement configuration information includes a priority level, there can be two cases regarding the priority level.

In the first case, the priority level is a plurality of group priority levels, each of the plurality of group priority levels corresponds to a group, each group includes at least one of the N to-be-measured carriers.

The selection mode corresponding to the plurality of group priority levels includes that: a selected to-be-measured carrier is a to-be-measured carrier in a set group, where a priority level of the set group is greater than a first set priority level.

In the first case, the priority level is a plurality of carrier priority levels, and each of the plurality of carrier priority levels corresponds to a to-be-measured carrier.

In some embodiments, the selection mode corresponding to the plurality of carrier priority levels includes that: a carrier priority level of a selected to-be-measured carrier is greater than a second set priority level.

In some embodiments, before step S202, the user equipment transmits a user equipment capability to the network device, where the user equipment capability is configured to indicate whether the user equipment supports a delay requirement enhancement for the second measurement.

The delay requirement enhancement for the second measurement includes the delay requirement enhancement for the layer 1 measurement and/or the delay requirement enhancement for the layer 1 measurement.

In some embodiments, supporting the delay requirement enhancement for the layer 1 measurement refers to supporting delay reduction for the layer 1 measurement. In some embodiments, supporting the delay requirement enhancement for the layer 1 measurement refers to supporting the delay for the Layer 1 measurement that is less than the agreed duration, which is less than the delay for the Layer 1 measurement defined in existing protocols. The existing protocol may be a R16 or R17 protocol.

Supporting the delay requirement enhancement for the layer 3 measurement refers to supporting delay reduction for the layer 3 measurement. In some embodiments, supporting the delay requirement enhancement for the layer 3 measurement refers to supporting the delay for the Layer 3 measurement that is less than the agreed duration, which is less than the delay for the Layer 3 measurement defined in existing protocols.

An embodiment of the present disclosure provides a method for determining a secondary cell which is performed by a network device. FIG. 6 is a flowchart illustrating a method for determining a secondary cell according to the embodiment of the present disclosure. As shown in FIG. 6, the method includes the following steps S601 to S603.

At step S601, measurement configuration information is transmitted to a user equipment.

The measurement configuration information is to configure N to-be-measured carriers.

In some embodiments, the measurement configuration information is to configure a selection parameter, and the selection parameter includes at least one of: an effective duration threshold, a signal strength threshold, or a priority level.

At step S602, a second measurement result transmitted by the user equipment is received, where the second measurement result is a measurement result obtained by performing a second measurement on M to-be-measured carriers of the N to-be-measured carriers in response to an access service cell event.

At step S603, based on the second measurement result, a secondary cell in multi-links is determined.

In some embodiments, before step S601, the method further includes receiving a user equipment capability transmitted by the user equipment, where the user equipment capability is configured to indicate whether the user equipment supports a delay requirement enhancement for the second measurement. Therefore, the network device can know the capabilities of different UEs and can use the capabilities of different UEs in possible processing.

Based on the same conception as the method embodiments, embodiments of the present disclosure further provide a communication device that may have the functions of the user equipment 102 in the method embodiments and be used to perform the steps provided in the embodiments and performed by the user equipment 102. The functions may be implemented by software, or by hardware executing corresponding software. The hardware or software includes one or more modules corresponding to the above-mentioned functions.

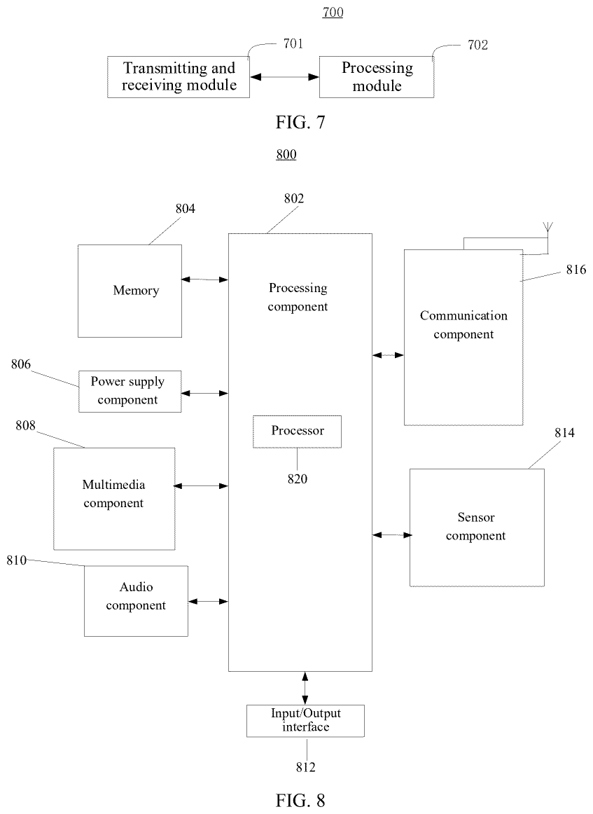

In an embodiment, the communication apparatus 700 as shown in FIG. 7 may serve as the user equipment 102 involved in the method embodiments and perform the steps performed by the user equipment 102 in the method embodiments.

The communication apparatus 700 includes a transmitting and receiving module 701, and a processing module 702.

The transmitting and receiving module is configured to receive measurement configuration information transmitted by a network device, where the measurement configuration information is to configure N to-be-measured carriers.

The processing module 702 is configured to: perform a first measurement on the N to-be-measured carriers when the user equipment is in a non-connected state (an idle/inactive state), to obtain a first measurement result; and perform a second measurement on M to-be-measured carriers of the N to-be-measured carriers in response to an access service cell event, to obtain a second measurement result, where M and N are positive integers and M is less than or equal to N.

The transmitting and receiving module 701 is further configured to transmit the second measurement result to the network device, where the second measurement result is configured to determine a secondary cell in multi-links.

In some embodiments, the measurement configuration information is to configure a selection parameter, and the selection parameter includes at least one of: an effective duration threshold, a signal strength threshold, or a priority level.

The processing module 702 is further configured to: select, based on the selection parameter and a selection mode corresponding to the selection parameter, the M to-be-measured carriers from the N to-be-measured carriers.

In some embodiments, the effective duration threshold is a first threshold, and the first threshold corresponds to the N to-be-measured carriers.

In some embodiments, the selection mode corresponding to the first threshold includes: in response to a set duration being greater than the first threshold, determining that M is equal to N, and selecting the N to-be-measured carriers, where the set duration is a duration between a first time and a second time (a duration from a first time to a second time), the first time is time when the first measurement is completed, and the second time is time when the access service cell event occurs.

In some embodiments, the effective duration threshold is K second thresholds, each of the K second thresholds corresponds to at least one of the N to-be-measured carriers, K is a positive integer, and K is less than or equal to N.

In some embodiments, the selection mode corresponding to the K second thresholds includes that a second threshold corresponding to a selected to-be-measured carrier is less than a set duration, where the set duration is a duration between a first time and a second time (a duration from a first time to a second time), the first time is time when the first measurement is completed, and the second time is time when the access service cell event occurs.

In some embodiments, the access service cell event is one of: transmitting a random access request to a service cell, receiving a paging message from the service cell, and transmitting a wireless link connection request to the service cell.

In some embodiments, the signal strength threshold is a third threshold, and the third threshold corresponds to the N to-be-measured carriers.

The selection mode corresponding to the third threshold includes: selecting a to-be-measured carrier, whose signal strength value is greater than the third threshold value, from the first measurement result.

In some embodiments, the signal strength threshold is L fourth thresholds, each of the L fourth thresholds corresponds to at least one of the N to-be-measured carriers, L is a positive integer, and L is less than or equal to N.

The selection mode corresponding to the L fourth thresholds includes: selecting a to-be-measured carrier, whose signal strength value is greater than or equal to a fourth threshold corresponding to the to-be-measured carrier, from the first measurement result, or selecting a to-be-measured carrier, whose signal strength value is less than a fourth threshold corresponding to the to-be-measured carrier, from the first measurement result.

In some embodiments, the priority level is a plurality of group priority levels, each of the plurality of group priority levels corresponds to a group, each group includes at least one of the N to-be-measured carriers.

The selection mode corresponding to the plurality of group priority levels includes that: a selected to-be-measured carrier is a to-be-measured carrier in a set group, where a priority level of the set group is greater than a first set priority level.

In some embodiments, the priority level is a plurality of carrier priority levels, and each of the plurality of carrier priority levels corresponds to a to-be-measured carrier.

The selection mode corresponding to the plurality of carrier priority levels includes that: a carrier priority level of a selected to-be-measured carrier is greater than a second set priority level.

In some embodiments, the method further includes: transmitting a user equipment capability to the network device, where the user equipment capability is configured to indicate whether the user equipment supports a delay requirement enhancement for the second measurement.

In some embodiments, the second measurement is a measurement for reference signal receiving power based on a layer 1 or a measurement for reference signal receiving power based on a layer 3.

When a communication device is a network device, its structure may also be shown in FIG. 8. FIG. 8 is a block diagram illustrating a measurement device 800 according to an example. For example, the device 800 can be a mobile phone, a computer, a digital broadcast terminal, a message transmitting and receiving device, a gaming console, a tablet device, a medical device, a fitness device, a personal digital assistant, and the like.

Referring to FIG. 8, the device 800 can include one or more of the following components: a processing component 802, a memory 804, a power supply component 806, a multimedia component 808, an audio component 810, an input/output (I/O) interface 812, a sensor component 814, and a communication component 816.

The processing component 802 usually controls overall operations of the device 800, such as operations related to display, a telephone call, data communication, a camera operation and a record operation. The processing component 802 may include one or more processors 820 to execute instructions to complete all or a part of the steps of the above methods. In addition, the processing component 802 may include one or more modules which facilitate the interaction between the processing component 802 and other components. For example, the processing component 802 may include a multimedia module to facilitate the interaction between the multimedia component 808 and the processing component 802.

The memory 804 is configured to store different types of data to support operations at the device 800. Examples of such data include instructions, contact data, phone book data, messages, pictures, videos, and so on for any application or method that operates on the device 800. The memory 804 may be implemented by any type of volatile or non-volatile storage devices or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic or optical disk.

The power supply component 806 supplies power for different components of the device 800. The power supply component 806 may include a power supply management system, one or more power supplies, and other components associated with generating, managing and distributing power for the device 800.

The multimedia component 808 includes a screen for providing an output interface between the device 800 and a user. In some embodiments, the screen may include a liquid crystal display (LCD) and/or a touch panel (TP). If the screen includes a touch panel, the screen may be implemented as a touch screen for receiving an input signal from a user. The touch panel may include one or more touch sensors for sensing a touch, a slide and a gesture on the touch panel. The touch sensor may not only sense a boundary of a touching or sliding movement, but also detect duration and pressure related to the touching or sliding operation. In some examples, the multimedia component 808 may include a front camera and/or a rear camera. When the device 800 is in an operation mode, such as a shooting mode or a video mode, the front camera and/or the rear camera may receive external multimedia data. Each of the front camera and the rear camera may be a fixed optical lens system or be of a focal length and a capability of an optical zoom.

The audio component 810 is configured to output and/or input an audio signal. For example, the audio component 810 may include a microphone (MIC). When the device 800 is in an operating mode, such as a call mode, a recording mode and a speech recognition mode, the microphone is configured to receive an external audio signal. The received audio signal may be further stored in the memory 804 or sent via the communication component 816. In some examples, the audio component 810 also includes a speaker for outputting an audio signal.

The I/O interface 812 may provide an interface between the processing component 802 and peripheral interface modules. The above peripheral interface modules may include a keyboard, a click wheel, buttons and so on. Such buttons may include but not limited to: a home button, a volume button, a start button and a lock button.

The sensor component 814 includes one or more sensors for providing state assessments in different aspects for the device 800. For example, the sensor component 814 may detect an on/off state of the device 800 and a relative location of components. For example, the components are a display and a keypad of the device 800. The sensor component 814 may also detect a position change of the device 800 or a component of the device 800, presence or absence of a touch of a user on the device 800, an orientation or acceleration/deceleration of the device 800, and a temperature change of the device 800. The sensor component 814 may include a proximity sensor for detecting the existence of a nearby object without any physical touch. The sensor component 814 may also include a Complementary Metal-Oxide-Semiconductor (CMOS) or Charged Coupled Device (CCD) image sensor applied in an imaging application. In some examples, the sensor component 814 may also include an acceleration sensor, a gyro sensor, a magnetic sensor, a pressure sensor, or a temperature sensor.

The communication component 816 is configured to facilitate wired or wireless communication between the device 800 and other devices. The device 800 may access a wireless network based on a communication standard, such as WiFi, 4G or 5G, or a combination thereof. In examples, the communication component 816 receives a broadcast signal or broadcast related information from an external broadcast management system via a broadcast channel. In examples, the communication component 816 may also include a Near Field Communication (NFC) module to facilitate short-range communications. For example, the NFC module may be implemented based on a radio frequency identification (RFID) technology, an infrared data association (IrDA) technology, an ultra wide band (UWB) technology, a bluetooth (BT) technology and other technologies.

In an example, the device 800 may be implemented by one or more application specific integrated circuits (ASIC), digital signal processors (DSP), digital signal processing devices (DSPD), programmable logic devices (PLD), field programmable gate arrays (FPGA), controllers, microcontrollers, microprocessors or other electronic elements, for executing the method in any one of the above examples.

In an example, a non-transitory computer readable storage medium including instructions, such as the memory 804 including instructions, is also provided. The above instructions may be executed by the processor 820 of the device 800 to complete the above method. For example, the non-transitory computer readable storage medium may be a read-only memory (ROM), a random access memory (RAM), a CD-ROM, a magnetic tape, a floppy disk and an optical data storage device, etc.

Based on the same conception as the method embodiments, embodiments of the present disclosure further provide a communication device that may have the functions of the network device 101 in the method embodiments and be used to perform the steps provided in the above-mentioned embodiments and performed by the network device 101. The functions may be implemented by software, or by hardware executing corresponding software. The hardware or software includes one or more modules corresponding to the above-mentioned functions.

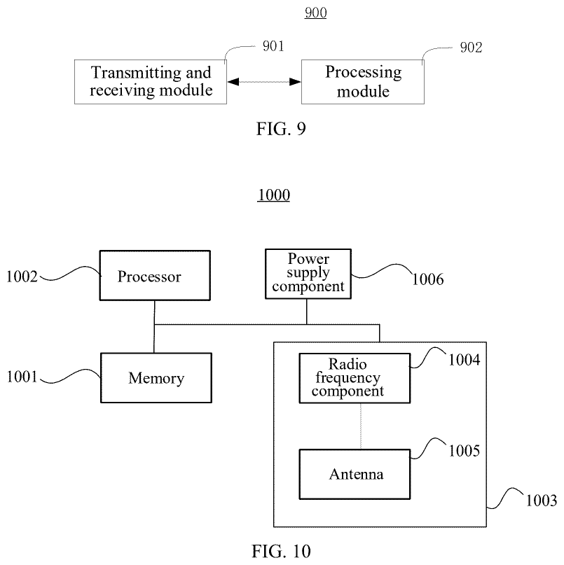

In an embodiment, the communication apparatus 900 as shown in FIG. 9 may serve as the network device 101 involved in the method embodiments and perform the steps performed by the network device 101 in the method embodiments.

The communication apparatus 900 includes a transmitting and receiving module 901, and a processing module 902.

The transmitting and receiving module is configured to: transmit measurement configuration information to a user equipment, where the measurement configuration information is to configure N to-be-measured carriers; and receive a second measurement result transmitted by the user equipment, where the second measurement result is a measurement result obtained by performing a second measurement on M to-be-measured carriers of the N to-be-measured carriers in response to an access service cell event.

The processing module is configured to determine, based on the second measurement result, a secondary cell in multi-links.

In some embodiments, the measurement configuration information is to configure a selection parameter, and the selection parameter includes at least one of: an effective duration threshold, a signal strength threshold, or a priority level.

In some embodiments, a user equipment capability transmitted by the user equipment is received, where the user equipment capability is configured to indicate whether the user equipment supports a delay requirement enhancement for the second measurement.

When a communication device is a network device 101, its structure may also be shown in FIG. 10. As shown in FIG. 10, the communication device 1000 includes a memory 1001, a processor 1002, a transmitting and receiving component 1003, and a power supply component 1006. The memory 1001 is coupled to the processor 1002 and may be configured to store programs and data necessary for the communication device 1000 to implement various functions. The processor 1002 is configured to support the communication device 1000 to perform the corresponding function in the above-mentioned methods, which can be realized by calling the programs stored in the memory 1001. The transmitting and receiving component 1003 may be a wireless transceiver that may be used to support the communication device 1000 to receive signaling and/or data through a radio Interface, as well as to transmit signaling and/or data. The transmitting and receiving component 1003 may also be referred to as a transmitting and receiving unit or a communication unit, and the transmitting and receiving component 1003 may include an radio frequency (RF) component 1004 and one or more antennas 1005, where the RF component 1004 may be a remote radio unit (RRU), which may be specifically used for transmission of RF signals and conversion of RF signals to baseband signals, and the one or more antennas 1005 may be specifically used to perform radiation and reception of RF signals.

When the communication device 1000 needs to transmit data, the processor 1002 can perform baseband processing on the data to be transmitted, and then output a baseband signal to the radio frequency unit, and the radio frequency unit performs radio frequency processing on the baseband signal and then transmits the radio frequency signal in the form of electromagnetic waves through the antenna. When there is data transmitted to the communication device 1000, the radio frequency unit receives the radio frequency signal through the antenna, converts the radio frequency signal to a baseband signal, and outputs the baseband signal to the processor 1002, and the processor 1002 converts the baseband signal to data and processes the data.

After considering the specification and practicing the present disclosure, those skilled in the art would easily conceive of other implementations of the present disclosure. The present disclosure is intended to include any variations, uses and adaptive changes of the present disclosure. These variations, uses and adaptive changes follow the general principle of the present disclosure and include common knowledge or conventional technical means in the prior art not disclosed in the present disclosure. The specification and examples are considered as exemplary only, with a true scope and spirit of the present disclosure being indicated by the following claims.

It is to be understood that the present disclosure is not limited to the precise construction described herein and shown in the drawings, and that various modifications and changes may be made without departing from the scope thereof. The scope of the present disclosure is to be limited only by the appended claims.

### Industrial Utility

The user equipment in an idle state or an inactive state accesses a service cell after completing an early measurement report (EMR), and in the process of accessing the service cell, some or all of the carriers that have been measured in the EMR are measured again in order to prevent the measurement results of the EMR from having expired, and this measurement that is performed again can be considered as an enhanced measurement of the EMR, and the measurement result of this enhanced measurement is more accurate than the measurement result of the EMR, so that the secondary cell in the multi-links can be determined based on the measurement result of the enhanced measurement, and the secondary cell with better signal quality can be determined, so as to ensure the link performance of the link between the user equipment and the secondary cell in the multi-links, and to improve the overall link quality of the multi-links.

1. A measurement method, performed by a user equipment, and comprising:
receiving measurement configuration information transmitted by a network device, wherein the measurement configuration information is to configure N to-be-measured carriers;
performing a first measurement on the N to-be-measured carriers when the user equipment is in a non-connected state, to obtain a first measurement result;
performing a second measurement on M to-be-measured carriers of the N to-be-measured carriers in response to an access service cell event, to obtain a second measurement result, wherein M and N are positive integers and M is less than or equal to N; and
transmitting the second measurement result to the network device, wherein the second measurement result is configured to determine a secondary cell in multi-links.

2. The method of claim 1, wherein the measurement configuration information is further to configure a selection parameter, and the selection parameter comprises at least one of: an effective duration threshold, a signal strength threshold, or a priority level; and
wherein the method further comprises: selecting, based on the selection parameter and a selection mode corresponding to the selection parameter, the M to-be-measured carriers from the N to-be-measured carriers.

3. The method of claim 2, wherein the effective duration threshold is a first threshold, and the first threshold corresponds to the N to-be-measured carriers;
wherein the selection mode corresponding to the first threshold comprises: in response to a set duration being greater than the first threshold, determining that M is equal to N, and selecting the N to-be-measured carriers, wherein the set duration is a duration between a first time and a second time, the first time is time when the first measurement is completed, and the second time is time when the access service cell event occurs.

4. The method of claim 2, wherein the effective duration threshold is K second thresholds, each of the K second thresholds corresponds to at least one of the N to-be-measured carriers, K is a positive integer, and K is less than or equal to N; and
wherein the selection mode corresponding to the K second thresholds comprises that a second threshold corresponding to a selected to-be-measured carrier is less than a set duration, wherein the set duration is a duration between a first time and a second time, the first time is time when the first measurement is completed, and the second time is time when the access service cell event occurs.

5. The method of claim 1, wherein the access service cell event is any one of: transmitting a random access request to a service cell, receiving a paging message from the service cell, and transmitting a wireless link connection request to the service cell.

6. The method of claim 2, wherein the signal strength threshold is a third threshold, and the third threshold corresponds to the N to-be-measured carriers;
wherein the selection mode corresponding to the third threshold comprises: selecting a to-be-measured carrier, whose signal strength value is greater than the third threshold, from the first measurement result.

7. The method of claim 2, wherein the signal strength threshold is L fourth thresholds, each of the L fourth thresholds corresponds to at least one of the N to-be-measured carriers, L is a positive integer, and L is less than or equal to N;
wherein the selection mode corresponding to the L fourth thresholds comprises: selecting a to-be-measured carrier, whose signal strength value is greater than or equal to a fourth threshold corresponding to the to-be-measured carrier, from the first measurement result, or selecting a to-be-measured carrier, whose signal strength value is less than a fourth threshold corresponding to the to-be-measured carrier, from the first measurement result.

8. The method of claim 2, wherein the priority level is a plurality of group priority levels, each of the plurality of group priority levels corresponds to a group, and each group comprises at least one of the N to-be-measured carriers;
wherein the selection mode corresponding to the plurality of group priority levels comprises that: a selected to-be-measured carrier is a to-be-measured carrier in a set group, wherein a priority level of the set group is greater than a first set priority level.

9. The method of claim 2, wherein the priority level is a plurality of carrier priority levels, and each of the plurality of carrier priority levels corresponds to a to-be-measured carrier;
wherein the selection mode corresponding to the plurality of carrier priority levels comprises that: a carrier priority level of a selected to-be-measured carrier is greater than a second set priority level.

10. The method of claim 1, further comprising:
transmitting a user equipment capability to the network device, wherein the user equipment capability is configured to indicate whether the user equipment supports a delay requirement enhancement for the second measurement.

11. The method claim 1, wherein the second measurement is a measurement for reference signal receiving power based on a layer 1 or a measurement for reference signal receiving power based on a layer 3.

12. A method for determining a secondary cell, performed by a network device, and comprising:
transmitting measurement configuration information to a user equipment, wherein the measurement configuration information is to configure N to-be-measured carriers;
receiving a second measurement result transmitted by the user equipment, wherein the second measurement result is a measurement result obtained by performing a second measurement on M to-be-measured carriers of the N to-be-measured carriers in response to an access service cell event; and
determining, based on the second measurement result, a secondary cell in multi-links.

13. The method of claim 12, wherein
the measurement configuration information is to configure a selection parameter, and the selection parameter comprises at least one of: an effective duration threshold, a signal strength threshold, or a priority level.

14. The method of claim 12, further comprising:
receiving a user equipment capability transmitted by the user equipment, wherein the user equipment capability is configured to indicate whether the user equipment supports a delay requirement enhancement for the second measurement.

15-16. (canceled)

17. A user equipment, comprising a processor and a memory, wherein
the memory is configured to store computer programs; and
the computer programs, when executed by the processor, cause the processor to perform operations comprising:
receiving measurement configuration information transmitted by a network device, wherein the measurement configuration information is to configure N to-be-measured carriers;
performing a first measurement on the N to-be-measured carriers when the user equipment is in a non-connected state, to obtain a first measurement result;
performing a second measurement on M to-be-measured carriers of the N to-be-measured carriers in response to an access service cell event, to obtain a second measurement result, wherein M and N are positive integers and M is less than or equal to N; and
transmitting the second measurement result to the network device, wherein the second measurement result is configured to determine a secondary cell in multi-links.

18. A network device, comprising a processor and a memory, wherein
the memory is configured to store computer programs; and
the computer programs, when executed by the processor, cause the processor to perform the method of claim 12.

19. A non-transitory computer-readable storage medium, storing instructions thereon, wherein the instructions, when executed by a computer, cause the computer to perform the method of claim 1.

20. A non-transitory computer-readable storage medium, storing instructions thereon, wherein the instructions, when executed by a computer, cause the computer to perform the method of claim 12.
